(19) United States
(12) Patent Application Publication
(10) Pub. No.: US 2012/0191816 A1
(43) Pub. Date: Jul. 26, 2012

(54) METHOD AND APPARATUS FOR COLLECTING DIAGNOSTIC INFORMATION

(75) Inventors: Steven R. Beckhardt, Boston, MA (US); Nicholas A.J. Millington, Santa Barbara, CA (US)

(73) Assignee: Sonos Inc.

(21) Appl. No.: 13/272,840

(22) Filed: Oct. 13, 2011

Related U.S. Application Data
(60) Provisional application No. 61/392,538, filed on Oct. 13, 2010.

(51) Int. Cl. G06F 15/16

(52) U.S. Cl. 709/219

(57) ABSTRACT

Certain embodiments provide systems, methods, and apparatus for playback network diagnostics. An example method includes facilitating a connection between a server and a first playback device, the first playback device connected with a plurality of playback devices via a network, the first playback including a network topology. The example method includes receiving, at the server, data collected at the first playback device. The example method includes receiving, at the server via the first playback device, data collected from each of the plurality of playback devices identified in the network topology of the first playback device, the data routed by the first playback device to the server. The example method includes analyzing the received data to determine a status of the playback devices in the network topology.

### CROSS-REFERENCE TO RELATD APPLICATIONS

The present application claims the benefit of priority to U.S. Provisional Application No. 61/392,538, filed on Oct. 13, 2010, entitled “Method and Apparatus for Collecting Diagnostic Information”, which is herein incorporated by reference in its entirety.

### BACKGROUND

1. Field of the Invention

The present invention is related to the area of data communication between clients and servers, and more specifically related to techniques for submitting diagnostic information by a networked-device to a web server as well as collecting an unlimited amount of diagnostic information from other devices and submitting the aggregate information to a web server.

2. Background

Many devices are designed to collect various status data and store the data therein for analysis by a professional. For example, modern vehicles are equipped with the capability to collect diagnostic data. By reading the data or code designed therefor, a technician is able to tell what part of a vehicle may go wrong or need attention.

With the advancement in the Internet, technologies have been developed to read off various data from a remotely installed computing device. The data may be uploaded to a designed device for analysis. The data may tell what version of software is installed in the device, what applications are installed and their running status. When there are multiple devices working together as a system, except for collecting the data individually from each of the devices, there is no effective solution yet how to collect aggregated data about the whole system.

### BRIEF DESCRIPTION OF THE DRAWINGS

Certain embodiments of the present invention will be readily understood by the following detailed description in conjunction with the accompanying drawings, wherein like reference numerals designate like structural elements, and in which:

FIG. 1 shows an example playback network configuration;

FIG. 2A shows an example functional block diagram of a zone player;

FIG. 2B shows an example controller that may be used to remotely control one of more zone players;

FIG. 2C shows an exemplary internal functional block diagram of a controller;

FIG. 3 shows a functional block diagram of a server configured to receive data from one or more devices on an ad hoc network;

FIG. 4 illustrates an example of aggregated data structure; and

FIG. 5 shows a flowchart for an example method or process of receiving data from several devices formed as a system or an ad-hoc network.

FIG. 6 illustrates a flowchart for an example method or process of receiving data from an ad hoc network.

### DETAILED DESCRIPTION OF CERTAIN EMBODIMENTS

The detailed description of certain embodiments is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Certain embodiments provide techniques of manually or automatically collecting the aggregated data from a plurality of devices and sending the data to a designated server, where the total amount of aggregated data that is to be uploaded to the server may be far more than any single device can store on its own.

In certain embodiments, a user requests a diagnostic upload from a device, such as a device configured for playback of multimedia content (also referred to herein as a playback device, zone player, or speaker) via a user command (e.g., from a hand-held controller communicating to the device over a network). The device contacts every other device known in its network topology and collects diagnostic data from those device(s). As the data is collected, the data is simultaneously (or substantially simultaneously given a data transmission, data storage, and/or processing delay, for example) uploaded to a web server via a hypertext transfer protocol (HTTP) Post command. In certain examples, since an ultimate size of the diagnostic data is unknown, chunked encoding is used. When completed, the upload status is returned to the user.

### BRIEF DESCRIPTION

Certain embodiments provide a method for collecting data from a group of playback devices forming a playback system having a network topology. The example method includes initiating a request to collect diagnostic data regarding the group of playback devices about the system in response to an initialization from a device in the group. The example method includes receiving streams of diagnostic data regarding the group of playback devices, wherein each of the data streams is collected by and sent from one of the devices in the group. The example method includes aggregating the data streams to form a data set for review. The example method includes analyzing the data set to determine a status of each of the devices and the playback system.

Certain embodiments provide a method for playback network diagnostics. The example method includes facilitating a connection between a server and a first playback device, the first playback device connected with a plurality of playback devices via a network, the first playback including a network topology. The example method includes receiving, at the server, data collected at the first playback device. The example method includes receiving, at the server via the first playback device, data collected from each of the plurality of playback devices identified in the network topology of the first playback device, the data routed by the first playback device to the server. The example method includes analyzing the received data to determine a status of the playback devices in the network topology.

Certain embodiments provide a server configured to communicate with a playback network. The example server includes an interface to communicate with a first playback device, the first playback device connected with a plurality of playback devices via a network, the first playback including a network topology. The example server includes a processor to initiate collection of data from the first playback device. The example server includes a monitoring module to monitor data received at the server from the first playback device, the data to include data from the first playback device and data collected from each of the plurality of playback devices identified in the network topology of the first playback device, the data to be routed by the first playback device to the server. The monitoring module is to analyze the received data to determine a status of the playback devices in the network topology.

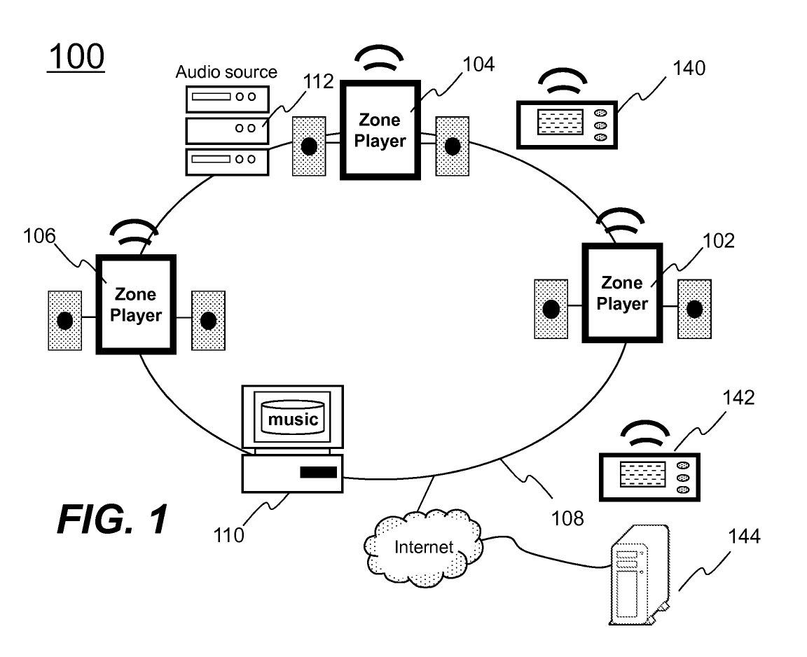

Referring now to the drawings, in which like numerals refer to like parts throughout the several views, FIG. 1 shows an exemplary playback network configuration 100 in which certain embodiments may be practiced. The configuration may represent, but not be limited to, a part of a residential home, a business, a building, a vehicle, or a complex with multiple zones. There are a number of multimedia players of which three examples 102, 104 and 106 are shown as audio devices. Each of the audio devices may be installed or provided in one particular area or zone and hence are referred to as a zone player herein.

As used herein, unless explicitly stated otherwise, a track and an audio source are used interchangeably. In certain embodiments, an audio source or audio sources are in digital format and can be transported or streamed across a data network. To facilitate the understanding of certain embodiments of the present invention, it is assumed, for purposes of illustration only, that the configuration 100 represents a home. Thus, the zone players 102 and 104 may be located in two of the bedrooms respectively while the zone player 106 may be installed in a living room. All of the zone players 102, 104 and 106 are coupled directly or indirectly to a data network 108 that is also referred to as ad hoc network formed by a plurality of zone players and one or more controllers. In addition, a computing device 110 is shown to be coupled on the network 108. Other device(s) such as a home gateway device, a storage device, or an MP3 player may be coupled to the network 108 as well. The configuration 100 may represent a building, a vehicle, and/or other location apart from a home, for example.

The network 108 may be a wired network, a wireless network or a combination of both. In one example, all devices including the zone players 102, 104 and 106 are wirelessly coupled to the network 108 based on an industry standard such as IEEE 802.11. In another example, all devices including the zone players 102, 104 and 106 are part of a local area network that communicates with a wide area network (e.g., the Internet).

All devices on the network 108 may be configured to download and store audio sources or receive streaming audio sources. For example, the computing device 110 may download audio sources from the Internet and store the downloaded sources locally for sharing with other devices on the Internet or the network 108. The zone player 106 may be configured to receive streaming audio source and share the source with other devices. Shown as a stereo system, the device 112 is configured to receive an analog source (e.g., from broadcasting) or retrieve a digital source (e.g., from a compact disk). The analog sources can be converted to digital sources. In certain embodiments, all audio sources, regardless of where they are located or how they are received, may be shared among the devices on the network 108.

Any device on the network 108 may be configured to control operations of playback devices, such as the zone players 102, 104 and 106. In particular, one or more controlling devices 140 and 142 are used to control zone players 102, 104 and 106 as shown in FIG. 1. The controlling devices 140 and 142 are, for example, portable and remotely control the zone players via a wireless data communication interface (e.g., infrared, radio, wireless standard IEEE 802.11b or 802.11 g, etc.). In an embodiment, besides controlling an individual zone player, the controlling device 140 or 142 is configured to manage audio sources and other characteristics of all the zone players regardless where the controlling device 140 or 142 is located in a house or a confined complex.

In certain embodiments, a playback device may communicate with and/or control other playback devices. For example, one zone player may provide data to one or more other zone players. A zone player may serve as a master device in one configuration and a slave device in another configuration, for example.

Also shown is a server 144 provided to communicate with one or all of the devices on the network 108. The server 144 is provided to receive data from the network 108. According to an embodiment, each of the devices on the network 108 is configured to collect or retain some but not all of the data about the network 108. The data may be diagnostic data about the status of one or more particular devices and the overall system. Data from a single device may not be usable in a sense that the data may be insufficient to determine a status of an overall system or the network 108, although the data may include some indication about the device itself. In certain embodiments, data from some or all of the devices on the network may be aggregated. The total amount of data that needs to be uploaded to the server 144 may be more than any single device can store on its own.

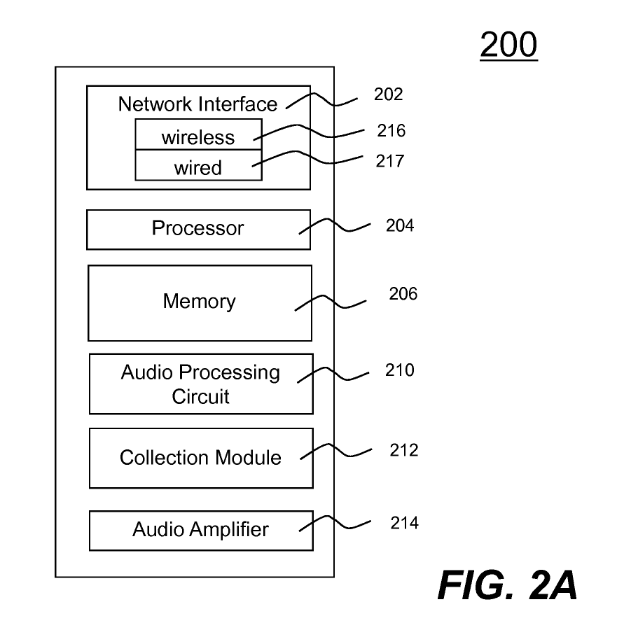

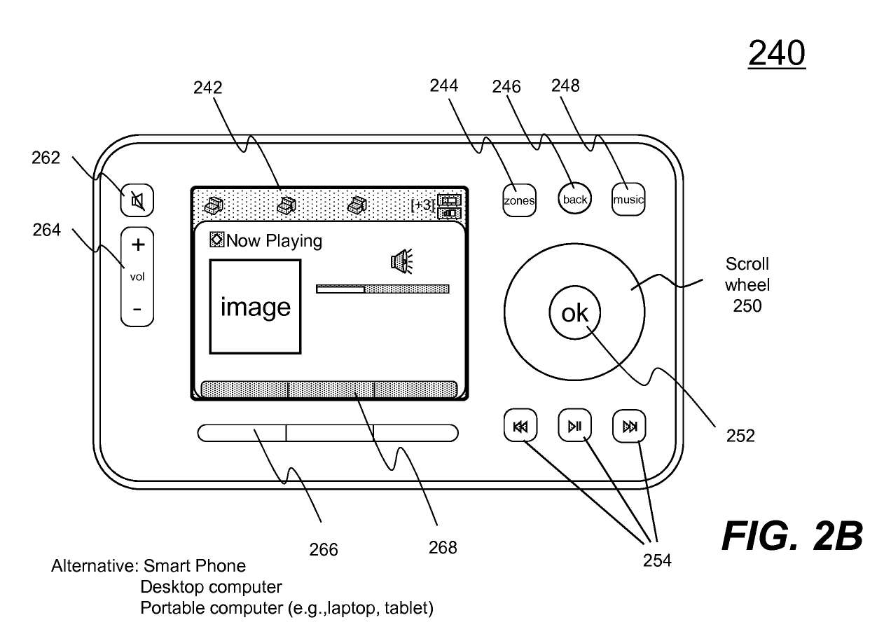

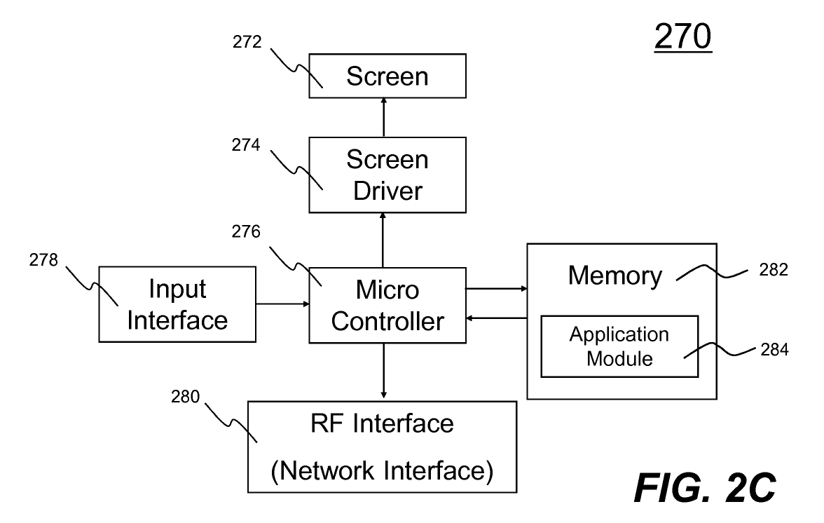

Referring now to FIG. 2A, there is shown an example functional block diagram of a zone player 200 in accordance with certain embodiments. The zone player 200 includes a network interface 202, a processor 204, a memory 206, an audio processing circuit 210, a collection module 212, and an audio amplifier 214. The network interface 202 facilitates a data flow between a data network (e.g., the data network 108 of FIG. 1) and the zone player 200 and typically executes a special set of rules (e.g., a protocol) to send data back and forth. One of the common protocols is TCP/IP (Transmission Control Protocol/Internet Protocol) commonly used in the Internet. In general, a network interface manages the assembling of an audio source or file into smaller packets that are transmitted over the data network or reassembles received packets into the original source or file. In addition, the network interface 202 handles the address part of each packet so that it gets to the right destination or intercepts packets destined for the zone player 200.

The network interface 202 may include either one or both of a wireless interface 216 and a wired interface 217. The wireless interface 216, also referred to as a radio frequency (RF) interface, provides network interface functions by (e.g., wirelessly) for the zone player 200 to communicate with other devices in accordance with a communication protocol (such as the wireless standard IEEE 802.11a, 802.11b or 802.11 g). The wired interface 217 provides network interface functions by a wired data communication interface or connection (e.g., an Ethernet cable). In an embodiment, a zone player, referred to as an access zone player, includes both of the interfaces 216 and 217, and other zone players include only the RF interface 216. Thus these other zone players communicate with other devices on a network or retrieve audio sources via the access zone player. The processor 204 is configured to control the operation of other parts in the zone player 200. The memory 206 may be loaded with one or more software modules that can be executed by the processor 204 to achieve desired tasks.

The audio processing circuit 210 resembles most of the circuitry in an audio playback device and includes one or more digital-to-analog converters (DAC), an audio preprocessing part, an audio enhancement part or a digital signal processor and others. In operation, when an audio source (e.g., a song or track, streaming audio source, and so on) is retrieved via the network interface 202, the audio source is processed in the audio processing circuit 210 to produce analog audio signals. The processed analog audio signals are then provided to the audio amplifier 214 for playback on speakers. In addition, the audio processing circuit 210 may include necessary circuitry to process analog signals as inputs to produce digital signals for sharing with other devices on a network.

Depending on an exact implementation, the data collection module 212 may be implemented within the audio processing circuit 210 or as a combination of hardware and software. The collection module 212 is provided to access different parts of the zone player and gather various data about the operation status thereof. As further described below, the module 210 may be configured to cause the collected data to be uploaded to the server (e.g., server 144 of FIG. 1) or a designed device in the system (e.g., another zone player or controller) to be aggregated with data from other devices before being uploaded to the server.

The audio amplifier 214 includes an analog circuit that powers the provided analog audio signals to drive one or more speakers. In an embodiment, the amplifier 214 is automatically powered off when there is no incoming data packets representing an audio source or powered on when the zone player is configured to detect the presence of the data packets.

Referring now to FIG. 2B, there is shown an example of a controller 240, which may correspond to the controlling device 140 or 142 of FIG. 1. The controller 240 may be used to facilitate the control of multi-media applications, automation and others in a living complex. In particular, the controller 240 is configured to facilitate a selection of a plurality of audio sources available on the network, controlling operations of one or more zone players (e.g., the zone player 200) through a RF interface corresponding to the wireless interface 216 of FIG. 2A. According to an embodiment, the wireless interface is based on an industry standard (e.g., infrared, radio, wireless standard IEEE 802.11a, 802.11b or 802.11 g). When a particular audio source is being played in the zone player 200, a picture, if there is any, associated with the audio source may be transmitted from the zone player 200 to the controller 240 for display. In an embodiment, the controller 240 is used to select an audio source for playback. In another embodiment, the controller 240 is used to manage (e.g., add, delete, move, save, or modify) a playlist.

The user interface for the controller 240 includes a screen 242 (e.g., a LCD screen) and a set of functional buttons as follows: a “zones” button 244, a “back” button 246, a “music” button 248, a scroll wheel 250, “ok” button 252, a set of transport control buttons 254, a mute button 262, a volume up/down button 264, a set of soft buttons 266 corresponding to the labels 268 displayed on the screen 242.

The screen 242 displays various screen menus in response to a selection by a user. In one embodiment, the “zones” button 244 activates a zone management screen or “Zone Menu” to allow a user to group players in a number of desired zones so that the players are synchronized to play an identical playlist or tracks. The “back” button 246 may lead to different actions depending on the current screen. In an embodiment, the “back” button triggers the current screen display to go back to a previous one. In another embodiment, the ‘back” button negates the user's erroneous selection. The “music” button 248 activates a music menu, which allows the selection of an audio source (e.g., a song track) to be added to a playlist (e.g., a music queue) for playback.

The scroll wheel 250 is used for selecting an item within a list, whenever a list is presented on the screen 242. When the items in the list are too many to be accommodated in one screen display, a scroll indicator such as a scroll bar or a scroll arrow is displayed beside the list. When the scroll indicator is displayed, a user may rotate the scroll wheel 250 to either choose a displayed item or display a hidden item in the list. The “ok” button 252 is used to confirm the user selection on the screen 242 or activate a playback of an item.

There are three transport buttons 254, which are used to control the effect of the currently playing track. For example, the functions of the transport buttons may include play/pause and forward/rewind a track, move forward to the next track, or move backward to the previous track. According to an embodiment, pressing one of the volume control buttons such as the mute button 262 or the volume up/down button 264 activates a volume panel. In addition, there are three soft buttons 266 that can be activated in accordance with the labels 268 on the screen 242. It can be understood that, in a multi-zone system, there may be multiple audio sources being played respectively in more than one zone players. The music transport functions described herein shall apply selectively to one of the sources when a corresponding zone player is selected.

FIG. 2C illustrates an internal functional block diagram of an exemplary controller 270, which may correspond to the controller 240 of FIG. 2B. The screen 272 on the controller 270 may be a LCD screen. The screen 272 communicates with and is commanded by a screen driver 274 that is controlled by a microcontroller (e.g., a processor) 276. The memory 282 may be loaded with one or more application modules 284 that can be executed by the microcontroller 276 with or without a user input via the user interface 278 to achieve desired tasks. In an embodiment, an application module is configured to cause each of the zone players to upload the collected data to a designed device (e.g., another zone player or the controller) or a server (e.g., the server 184 of FIG. 2A).

In another embodiment, an application module is configured to facilitate other control functions for the zone players, for example, to initiate an uploading command to schedule or cause one or more zone players to collect data therein and send the data to a designated place. The command may include an IP address of the designated place. In another embodiment, the command includes instructions to request all zone players to upload the respective data to one of the zone players to assemble the data before being sent to the designated place. In operation, when the microcontroller 276 executes one of the application modules 284, the screen driver 274 generates control signals to drive screen 272 to display an application specific user interface accordingly, more of which will be described below.

The controller 270 includes a network interface 280, referred to as a RF interface 280, that facilitates wireless communication with a zone player via a corresponding wireless interface or RF interface thereof. The controller 270 may control one or more zone players, such as 102, 104 and 106 of FIG. 1. Nevertheless, there may be more than one controller, each in a zone (e.g., a room) and configured to control any one and all of the zone players, for example.

It should be pointed out that the controller 240 in FIG. 2B is not the only controlling device that may practice certain embodiments of the present invention. Other devices that provide the equivalent control functions (e.g., a computing device, a personal digital assistant (PDA), a hand-held device, a laptop computer, and so on) may also be configured to practice certain embodiments. In the above description, unless otherwise specifically described, keys or buttons are generally referred to as either the physical buttons or soft buttons, enabling a user to enter a command or data.

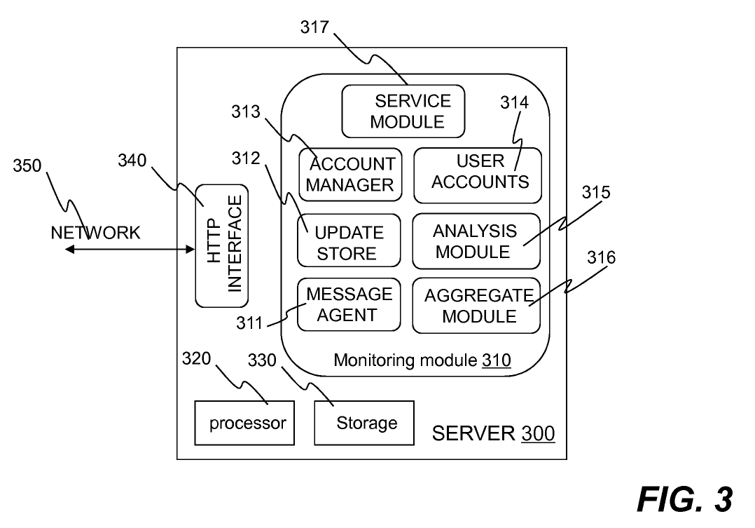

FIG. 3 shows a function block diagram 300 of a server configured to receive data from one or more devices (e.g., zone players) on an ad hoc network. The server includes a monitoring module 310 including a plurality of components or modules for aggregation, analysis, and management. For example, the monitoring module 310 may include a message agent 311, an update store 312, an account manager 313, user account(s) 314, an analysis module 315, an aggregate module 316, a service module 317, and so on. The example server 300 may also include a processor 320, a storage 330, and a network interface 340 (e.g., an HTTP interface). The interface 340 communicates with one or more connected playback devices (e.g., zone players, speakers, bridges, and so on) via the network 350.

For example, the server 300 receives data, such as diagnostic data, from one or more connected playback devices via the network interface 340. The monitoring module 310 monitors for initiation of data collection by command at the server 300, initiation from a connected playback device, pre-programmed collection, and so on. The message agent 311 facilitates an exchange of messages with connected playback devices to gather diagnostic data. The update store 312 facilitates updating of information at the server 300. The aggregate module 316 coordinates data aggregation from a plurality of playback devices at the server 300. The analysis module 315 analyzes the received data to identify usage, trends, problems, out-of-date versions, and so on.

The service module 317 can provide, based on feedback from the analysis module 315 and/or the update store 312, information to be sent to the one or more connected playback devices. Service information may include update information, upgrade information, patch or bug fix information, reset information, display format information, local diagnostics, and so on.

The account manager 313 may be used to manage one or more user account(s) 314. In certain embodiments, the account manager 313, alone or in conjunction with the analysis module 315, may track usage information for one or more connected devices associated with a user. For example, audio content playback, such as tracks, artists, genres, and so on, may be monitored and collected for aggregation and association with a user. Such user usage, habit, and/or preference information may assist a content provider in providing content to the user, for example.

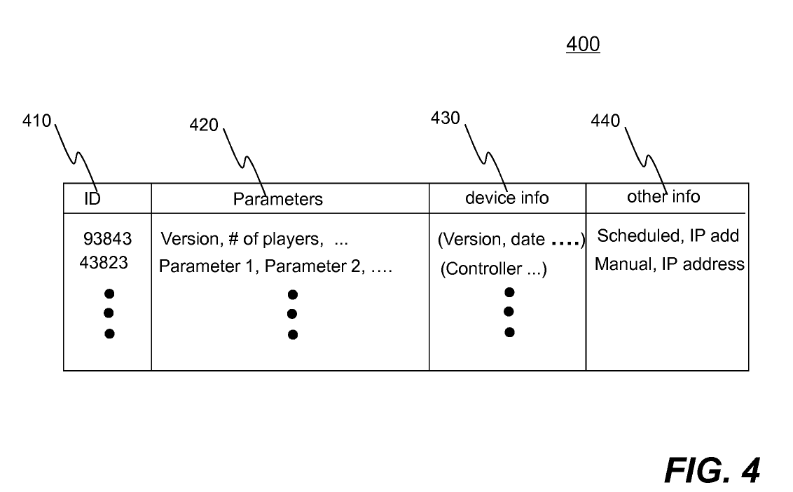

FIG. 4 shows example elements in aggregated data 400 received from an ad hoc network. As illustrated in the example aggregated data set 400, the data may include an identifier 410, one or more parameters 420, device information 430, other information 440, and so on. For example, parameters may include a version, a number of playback devices in a network, and so on. For example, device information may include version, data, controller information, and so on. Other information may include Internet Protocol (IP) address, manual playback information, scheduled playback information, and so on.

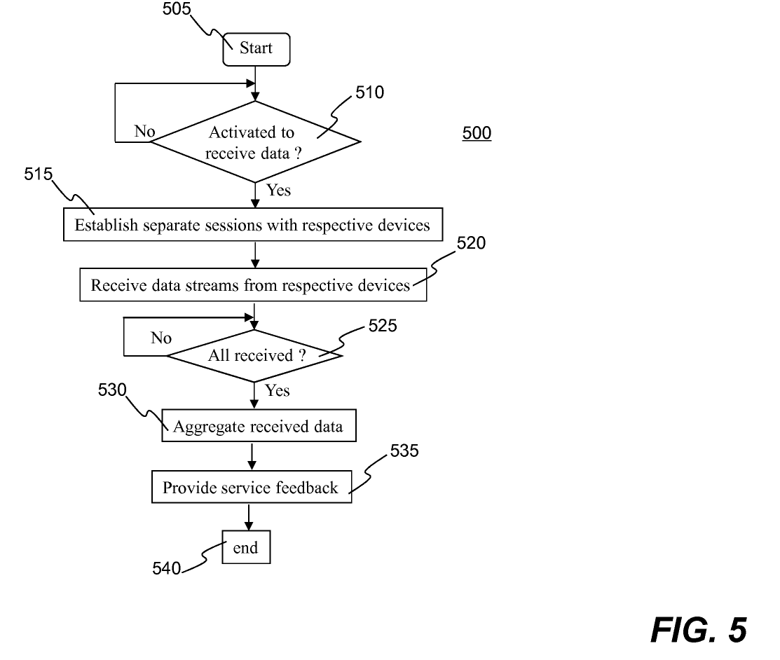

FIG. 5 shows a flowchart for an example method or process 500 of receiving data from an ad hoc network. At block 505, the process 500 begins for data aggregation. At block 510, the system is checked to determine if it has been activated to receive data. If no, the process 500 continues to wait for activation. If yes, then, at block 515, separate session(s) are established with respective device(s) to receive data.

At block 520, data streams are received from each respective monitored device for which a session is established. At block 525, the data streams are checked against the established sessions to determine whether all data streams have been received. If not, then the process 500 continues until all relevant data streams have been received. If so, then at block 530, the received data is aggregated. In an alternative embodiment, a session is established with one device that is configured to locally aggregate data from other devices.

At block 535, service feedback service is provided based on an analysis of the aggregated data. For example, a format to display, a module to be sent back, diagnostic analysis to be performed, and so on may be provided to the applicable playback device(s) for which sessions have been established. At block 540, the process 500 ends.

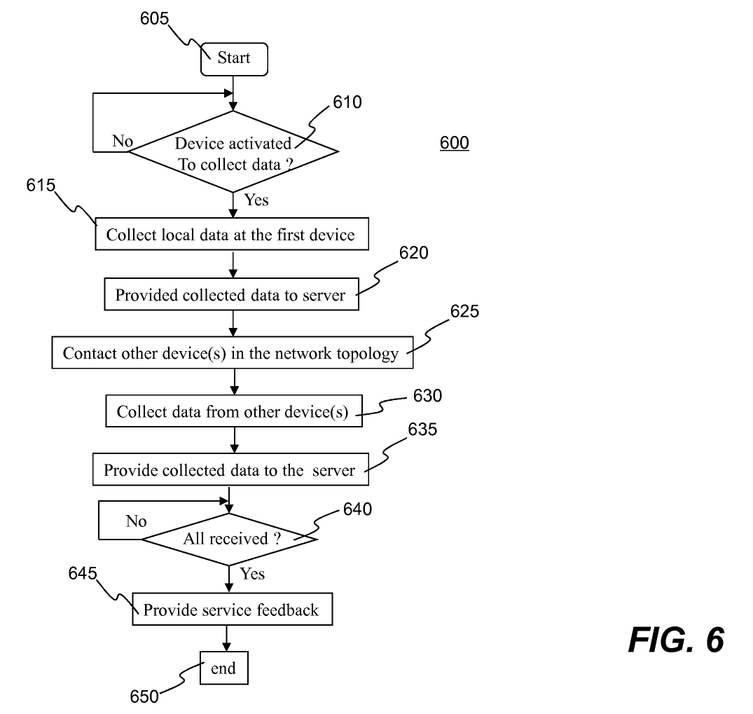

FIG. 6 illustrates a flowchart for an example method or process 600 of receiving data from an ad hoc network. At block 605, the process 600 begins for data collection. At block 610, a first device checks to determine if it has been activated to collect diagnostic data. If no, the process 600 continues to wait for activation. If yes, then, at block 615, local data is collected at the first device. At block 620, the first device provides collected data to a server for collection and analysis.

At block 625, the first device contacts one or more other devices residing in a network topology (e.g., the network 100) with the first device. At block 630, the first device collects data from the one or more other devices. Data may be collected in series from each device, data may be received at the first device from multiple other devices in association with an identifier for the sending device, and so on.

At block 635, the first device provides received data to the server for collection and analysis. Received data may be provided to the server as it is received by the first device or the data may be aggregated and then sent to the server, for example. At block 640, data streams received at the first device are checked against established sessions to determine whether all data streams have been received. If not, then the process 600 continues until all relevant data streams have been received. If so, then at block 645, service feedback service is provided based on an analysis of the aggregated data. For example, a format to display, a module to be sent back, diagnostic analysis to be performed, and so on may be provided to the applicable playback device(s) for which sessions have been established. For example, an update module may be provided to update on or more of the playback devices. A diagnostic module may be provided to perform local diagnostics at a playback device, for example. At block 650, the process 600 ends.

The processes, sequences or steps and features discussed above and in the appendix are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense (e.g., with less than the specific manner in which each of the processes or sequences has been reduced to practice in the disclosure herein).

The forgoing and attached are illustrative of various aspects/embodiments of the present invention, the disclosure of specific sequence/steps and the inclusion of specifics with regard to broader methods and systems are not intended to limit the scope of the invention which finds itself in the various permutations of the features disclosed and described herein as conveyed to one of skill in the art.

What is claimed is:

1. A method for collecting data from a group of playback devices forming a playback system having a network topology, the method comprising:
initiating a request to collect diagnostic data regarding the group of playback devices about the system in response to an initialization from a device in the group;
receiving streams of diagnostic data regarding the group of playback devices, wherein each of the data streams is collected by and sent from one of the devices in the group;
aggregating the data streams to form a data set for review; and
analyzing the data set to determine a status of each of the devices and the playback system.

2. The method of claim 1, further comprising providing feedback to one or more of the group of playback devices via the one of the devices collecting and sending the data streams based on analyzing the data set.

3. The method of claim 2, wherein the feedback comprises at least one of a format to display at one or more of the playback devices, an update module, and a diagnostic module.

4. The method of claim 1, further comprising establishing a connection between a server and the one of the group of playback devices and locally aggregating data from the others of the group of playback devices at the one playback device before sending the aggregated data to the server for collection and analysis.

5. The method of claim 4, further comprising initiating, by the one of the group of playback devices, a connection with each other of the group of playback devices in the network topology to request and receive diagnostic data.

6. The method of claim 1, wherein data is collected from the playback system and transmitted for analysis without user intervention.

7. The method of claim 1, further comprising providing a diagnostic data upload status.

8. A method for playback network diagnostics, the method comprising:
facilitating a connection between a server and a first playback device, the first playback device connected with a plurality of playback devices via a network, the first playback including a network topology;
receiving, at the server, data collected at the first playback device;
receiving, at the server via the first playback device, data collected from each of the plurality of playback devices identified in the network topology of the first playback device, the data routed by the first playback device to the server; and
analyzing the received data to determine a status of the playback devices in the network topology.

9. The method of claim 8, further comprising providing feedback to one or more of the plurality of playback devices via the first playback device.

10. The method of claim 9, wherein the feedback comprises at least one of a format to display at one or more of the playback devices, an update module, and a diagnostic module.

11. The method of claim 8, further comprising locally aggregating data from the plurality of playback devices at the first playback device before sending the aggregated data to the server for collection and analysis.

12. The method of claim 8, wherein data is collected from the plurality of playback devices and transmitted for analysis without user intervention.

13. The method of claim 12, wherein the connection between the first playback device and the server is automatically initiated without user intervention.

14. The method of claim 8, further comprising providing a data upload status.

15. A server configured to communicate with a playback network, the server comprising:
an interface to communicate with a first playback device, the first playback device connected with a plurality of playback devices via a network, the first playback including a network topology;
a processor to initiate collection of data from the first playback device; and
a monitoring module to monitor data received at the server from the first playback device, the data to include data from the first playback device and data collected from each of the plurality of playback devices identified in the network topology of the first playback device, the data to be routed by the first playback device to the server,
wherein the monitoring module is to analyze the received data to determine a status of the playback devices in the network topology.

16. The server of claim 15, wherein the monitoring module includes a service module to provide feedback to one or more of the plurality of playback devices via the first playback device.

17. The server of claim 15, wherein the feedback comprises at least one of a format to display at one or more of the playback devices, an update module, and a diagnostic module.

18. The server of claim 15, wherein the monitoring module comprises an aggregation module to aggregate data received via the first playback device and an analysis module to analyze the received data.

19. The server of claim 15, wherein the monitoring module is to monitor usage of at least one of the playback devices to gather usage information for a user.

20. The server of claim 15, wherein data collected includes an identifier, one or more parameters, and playback device information.
